(19) United States
(12) Patent Application Publication
(10) Pub. No.: US 2008/0199385 A1
(43) Pub. Date: Aug. 21, 2008

(54) Process for Producing Silica and Sodium Sulfite with Sodium Sulfate

(75) Inventor: Yuanjian Lu, Fujian (CN)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Degussa Wellink Silica(Nanping) Co. Ltd., Nanping, Fujian (CN)

(21) Appl. No.: 11/916,867

(22) PCT Filed: Jun. 6, 2006
(86) PCT No.: PCT/CN06/01228

§ 371 Date: Mar. 5, 2008

(30) Foreign Application Priority Data
Jun. 8, 2005 (CN) 200510200315.1

(51) Int. Cl. C01B 33/12

(52) U.S. Cl. 423/339

(57) ABSTRACT

Provided is a process for producing silica and sodium sulfite with sodium sulfate, wherein a mixture of quartz sand, sodium sulfate and carbon is reacted to produce solid sodium silicate and sulfur dioxide, which are used to produce silica and sodium sulfite through the following steps: (1) Said solid sodium silicate is dissolved in water and then filtered to obtain a sodium silicate solution; a sodium hydrogen sulfite solution is added to said sodium silicate solution to produce precipitated silica and sodium sulfite solution and the resultant mixture is filtered; (2) One part of the filtrate obtained at the end of step (1) is brought into contact with said sulfur dioxide and the product, sodium hydrogen sulfite, is recycled to step (1); (3) The filter cake obtained at the end of step (1) is acidified, followed by filtration, washing and drying to obtain silica; and (4) The other part of the filtrate obtained at the end of step (1) is concentrated and dried to obtain solid sodium sulfite. The process of the present invention is of great industrial value due to its simple steps, useful by-products and low production cost.

The present invention provides a process for producing silica and sodium sulfite with sodium sulfate.

Precipitated silica, also called light silicon dioxide or white carbon, is used as filler for rubber; as well as lubricant, insulation material, filling material of plastics, paper, paint and textile and white pigment. Nowadays, the most common method to produce silica is the precipitation method. Water glass (sodium silicate) employed in these processes is prepared by reaction of quartz sand with soda (anhydrate sodium carbonate). These processes, however, require a large quantity of soda, resulting in high production cost.

The purpose of the present invention is to provide a new process for preparing precipitated silica while reducing the cost of production and environmental problems.

The present invention involves the following reaction schemes:

²Na₂SO₄+2n SiO₂+C→2Na₂O.nSiO₂+2SO₂+CO₂

SO₂+Na₂SO₃+H₂O→2NaHSO₃

²NaHSO₃+Na₂O.nSiO₂→nSiO₂+2Na₂SO₃+H₂O

An embodiment of the present invention is a process for producing silica and sodium sulfite with sodium sulfate. Its character lies in using sodium sulfate instead of soda to produce sodium silicate. In addition, sodium hydrogen sulfite instead of sulfuric acid is used for the precipitation of silica.

In particular, a mixture of quartz sand, sodium sulfate and carbon in a weight ratio of 118.3˜147.9:100:4˜12 is heated at a temperature of 1200-1500° C. to produce solid sodium silicate and sulfur dioxide. Said solid sodium silicate and sulfur dioxide are used to prepare silica and sodium sulfite through the following steps:
(1) Said solid sodium silicate is dissolved with water in a weight ratio of 100:180˜488 and then filtered to obtain a sodium silicate solution. A sodium hydrogen sulfite (concentration: 1%-40%) is added into said sodium silicate solution in a mole ratio of 2:1 to produce precipitated silica and sodium sulfite solution. The reaction is proceeded at 70-95° C. over a period of 1-4 hours and the resultant mixture is filtered;
(2) The sulfur dioxide is added to one part of the filtrate obtained at the end of step (1) at 20-50° C. resulting in the formation of sodium hydrogen sulfite which can be reused in step (1);
(3) The filter cake obtained at the end of step (1) is acidified to pH 3.5-6.0, followed by filtration, washing and drying to obtain silica;
(4) The other part of the filtrate obtained at the end of step (1), which is not used in step (2), is concentrated and dried to obtain solid sodium sulfite, which is a valuable raw material for chemical and paper industries.

In a preferred embodiment of the invention, a thermal insulation horseshoe-flame furnace is used for the production of sodium silicate with sodium sulfate. The process of the present invention can be used as a batch process or a continuous process. A continuous production of water glass or continuous overall process is preferred.

Compared with the existing techniques, the present invention has the following advantages:

(I) No sodium hydroxide or soda needed, i.e., lower production cost because sodium sulfate is cheaper than soda;

(II) No Sulfuric acid or hydrochloric acid needed for the precipitation of silica, and only minor amount of acid necessary for the acidification of the filter cake, i.e., lower production cost;

(III) The by product sodium sulfite is a valuable material for different applications in chemical industry and can therefore be commercialized;

(IV) No waste.

The following examples are intended to demonstrate and explain the present invention without limitation or restriction of the scope of the invention.

### EXAMPLE

Quartz sand, sodium sulfate and carbon (crushed) were mixed in a weight ratio of 100:81.4:6.5. Said mixture was charged continuously into a thermal insulation horseshoe-flame furnace and heated to 1420-1450° C. The resultant solid sodium silicate was dissolved in water and filtered to obtain a 3.5 M and 29 Be′ sodium silicate (water glass) solution.

A 6 I reactor was charged with 0.043 I of said sodium silicate (water glass) solution and 1.875 I of water and heated to 85° C. During 90 minutes 0.706 I of said sodium silicate solution and 2.237 I of a 8.25% sodium hydrogen sulfite solution were metered in simultaneously. The reaction product was filtered and the filtrate containing sodium sulfite solution was recycled.

For obtaining desired precipitated silica, the pH value of the filter cake was adjusted to 4.5 with acid. After filtration, washing and drying, 209.5 g of silica with BET of 172 m²/g were obtained.

To reuse the filtrate, sulfur dioxide (5%) obtained during the production of the sodium silicate was added into half of the filtrate to produce sodium hydrogen sulfite (8.25% solution), which was recycled for silica production.

The other half of the filtrate was dried to get 112.37 g of solid sodium sulfite, which can be commercialized.

The process of the present invention is of great industrial value due to its simple steps and low production cost.

What is claimed is:

1. A process for producing silica and sodium sulfite by using sodium sulfate, characterized in that
quartz sand, sodium sulfate and carbon are mixed in a weight ratio of 118.3˜147.9:100:4˜12, and then transferred into a furnace and heated at a temperature of 1200-1500° C. to produce solid sodium silicate and sulfur dioxide;
said solid sodium silicate and sulfur dioxide are employed in the following steps to produce silica and sodium sulfite:
(1) Said solid sodium silicate is dissolved into water in a weigh ratio of 100:180˜488 and filtered to produce a sodium silicate solution; a sodium hydrogen sulfite solution with a concentration of 1-40% is added into said sodium silicate solution in a mole ratio of sodium hydrogen sulfite to sodium silicate of 2:1, and the mixture is reacted at 70-95° C. for 1˜4 hours to produce precipitated silica and sodium sulfite solution, and the resultant mixture is filtered;
(2) One part of the filtrate obtained at the end of step (1) is brought into contact with the sulfur dioxide obtained during the production of the sodium silicate at 20 to 50° C. to produce sodium hydrogen sulfite, which is reused for the reaction of step (1);
(3) The pH value of the filter cake obtained at the end of step (1) is adjusted to 3.5-6.0 followed by filtration, washing and drying to obtain silica; and
(4) The other part of the filtrate obtained at the end of step (1) is concentrated and dried to obtain sodium sulfite.

2. The process for producing silica and sodium sulfite according to claim 1, characterized in that said furnace is a thermal insulation horseshoe-flame furnace.
